(19) United States
(12) Patent Application Publication
(10) Pub. No.: US 2006/0155090 A1
(43) Pub. Date: Jul. 13, 2006

(54) Siloxane block copolymers

(75) Inventor: Michael Ferenz, Essen (DE)

Correspondence Address: FROMMER LAWRENCE & HAUG, 745 FIFTH AVENUE- 10TH FL., NEW YORK, NY, 10151, US

(73) Assignee: Goldschmidt GmbH

(21) Appl. No.: 11/327,234

(22) Filed: Jan. 6, 2006

(30) Foreign Application Priority Data
Jan. 7, 2005 (DE) 10 2005 001 041.5

(51) Int. Cl. C08G 77/04; C08G 77/06

(52) U.S. Cl. 528/31; 528/32; 528/29; 528/13

(57) ABSTRACT

The invention provides organopolysiloxanes obtained by A) addition reaction of organopolysiloxanes containing SiH groups with vinylsiloxanes in the presence of platinum catalysts or rhodium catalysts, with the proviso that the organopolysiloxanes are present in a molar excess of at least 6 times, relative to the vinylsiloxane, and further reaction of the reaction product in at least one of the following stages: B) transition metal-catalyzed partial or complete addition reaction of the SiH groups with alkenyl and/or alkynyl compounds, C) with the use of a catalyst, partial or complete reaction of the RSiH groups, remaining after above reaction(s), with at least one alcohol from the group of linear or branched, saturated, mono- or polyunsaturated, aromatic, aliphatic-aromatic, optionally halogen atom-containing monoalcohols, polyether monoalcohols, polyester monoalcohols, and amino alcohols.

The invention relates to new siloxane derivatives and to their use.

Any foregoing applications, and all documents cited therein or during their prosecution (“application cited documents”) and all documents cited or referenced in the application cited documents, and all documents cited or referenced herein (“herein cited documents”), and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention. Citation or identification of any document in this application is not an admission that such document is available as prior art to the present invention.

Organically modified siloxanes are employed in a multiplicity of applications. This is possible because the properties of the siloxane can be tailored via a variety of factors. These factors include, among others, the nature of the organic modification, the chain length and degree of branching of the siloxane, and the modification density.

The properties of the siloxane are also critically influenced by whether the siloxane in question has been given a comblike modification or a strictly difunctional α, ω-modification.

For certain applications the use of α, ω-modified siloxanes is of advantage. This is true, for example, of the use of siloxanes having quaternary ammonium functions as softeners for textiles. Here it has been found that α, ω-modified siloxanes are markedly superior to their counterparts with comblike modification (EP-B-0 294 642). Similar comments also apply to the use of silicone acrylates for producing adhesive coatings (EP-A-0 979 851). In these cases the positive performance properties are attributable to the presence of a long, unmodified, linear siloxane fragment.

Branched siloxane block copolymers also exhibit particular properties and are described in various patents (e.g. U.S. Pat. No. 5,136,068, EP-A-381 318). The feature of the siloxane block copolymers described is that the linkage is obtained in all cases by reaction of SiH groups with, for example, diolefins or 1,3-divinyltetramethyldisiloxane.

Siloxanes containing SiH and SiCl groups are particularly suitable starting products for organically modified siloxanes. The organic radicals are attached to the siloxane backbone by way of hydrosilylation reactions, addition reaction and/or dehydrogenative coupling.

For the preparation of α, ω-modified siloxanes this means that only two organic radicals can be introduced in these ways. In some cases, however, it is desirable to prepare siloxanes which have a higher degree of modification at the chain ends and yet contain an unmodified linear siloxane fragment.

It is subject matter of the present invention to provide such organosiloxanes and a process for their preparation.

It is noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the invention.

The essence of this invention lies in the targeted process combination for the construction of organically modified siloxanes, which allows siloxanes to be prepared which possess at least one relatively long, non-modified, linear siloxane fragment and whose chain ends are multiply modified.

These organopolysiloxanes are produced by the process comprising:

A) addition reaction of organopolysiloxanes of the general formula I 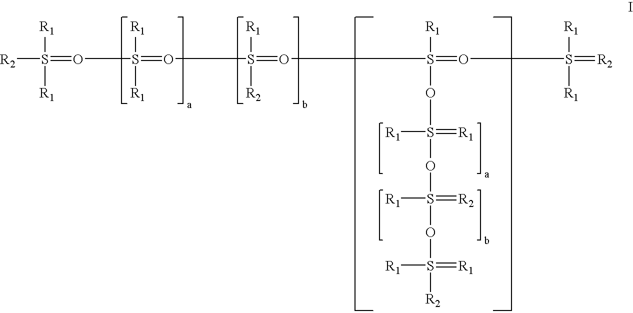
in which
R¹ denotes identical or different aliphatic or aromatic hydrocarbon radicals having 1 to 20 carbon atoms, preferably 1 to 4 carbon atoms, most preferably R¹ is methyl,
R² denotes R¹ or H, with the proviso that at least three radicals R² are H,
a is 5 to 500,
b is 1 to 50,
c is 0 to 5, preferably 0,
   with vinylsiloxanes of the general formula II, 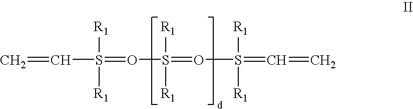
   where
d is 10 to 1000, in particular 30 to 750, more preferably 50 to 500; and
R¹ is as defined above,
   in the presence of platinum catalysts or rhodium catalysts,
   with the proviso that the organopolysiloxanes of the general formula I are present in a molar excess of at least 6 times, relative to the vinylsiloxane of the general formula II, preferably 6 to 50 times molar excess, most preferably 10 to 30 times molar excess,

and further reaction of the reaction product in at least one of the following stages:

B) transition metal-catalyzed partial or complete addition reaction of the SiH groups with alkenyl and/or alkynyl compounds,

C) with the use of a catalyst, partial or complete reaction of the RSiH groups, remaining after above reaction(s), with at least one alcohol from the group of linear or branched, saturated, mono- or polyunsaturated, aromatic, aliphatic-aromatic, optionally halogen atom-containing monoalcohols, polyether monoalcohols, polyester monoalcohols, and amino alcohols.

The measure whereby the SiH-bearing organopolysiloxane of the general formula I is present in a molar excess of at least 6 times, relative to the vinylsiloxane of the general formula II, prevents the formation of a network and the formation of high-viscosity products.

This means that in addition to the organosiloxane of the invention there is a certain fraction of a siloxane with comblike modification present in the product.

The organosiloxanes of the invention prepared by one of the two aforementioned processes generally possess viscosities up to 10,000 mpas, preferably below 5000 mPas. In one embodiment of the invention the viscosity is between about 100 mPas and below 5000 mPa. In another embodiment of the invention, the viscosity is between about 200 mPas and about 1000 mPas.

Owing to the chosen reaction conditions, the majority product of the vinylsiloxane and the Si-functional siloxane in the first stage is a siloxane of the following idealized “H structure” (c=0, R¹=Me, R²=R=Me or H):

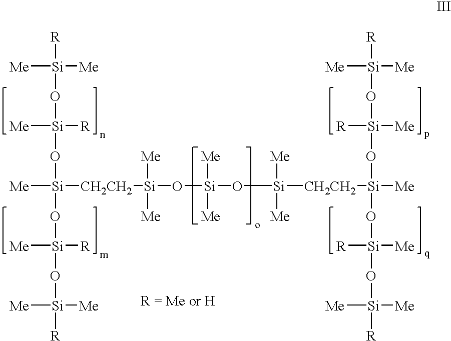

wherein,

n, m, p and q correlate to a and b in formula I;

o is 10 to 1000, in particular 30 to 750, more preferably 50 to 500;

This siloxane backbone is retained during the subsequent preparation of the siloxanes of the invention in the following stages.

It has been found that-the siloxanes of the invention can be prepared without solvent. The use of a solvent, however, may be advantageous. For instance, during the preparation of the siloxanes of the invention foam may be formed, and this foam can be suppressed by using solvents. These solvents can be selected by those of skill in the art (see e.g. Vogel's Textbook of Practical Organic Chemistry (Fifth Edition), ed. by Furniss et al., Longman Scientific & Technical, (1989)). Suitable solvents include but are not limited to saturated aliphatic hydrocarbons and aromatic hydrocarbons. Examples of saturated aliphatic hydrocarbons include but are not limited to pentane, hexane, heptane, octane, nonane, decane, undecane, dodecane, cyclopentane, cyclohexane, methylcyclohexane, cycloheptane and mixtures thereof. Examples of aromatic hydrocarbons include benzene, toluene, ethylbenzene, p-xylene, m-xylene, o-xylene, isopropylbenzene, naphthalene, anthracene, cyclohexylbenzene and mixtures thereof. In one embodiment of the invention, the solvent is toluene and cyclohexane.

Effective catalysts which can be used for the first step, the hydrosilylation of the vinylsiloxane, include Pt and Rh complexes known to the skilled worker as hydrosilylation-active catalysts, for example: H₂PtCl₆, Pt[(CH₂CH—Si)₂O]ₙ or Rh(CO) (C₅H₇O₂).

For the addition reaction of the alcohol with the resultant SiH-containing siloxane it is possible, for example, to use Lewis acids, preferably boron-containing Lewis acids. In one preferred embodiment of the invention the boron compound used in the catalytic system comprises fluorinated and/or non-fluorinated organoboron compounds, particularly those selected from: (C₅F₄) (C₆F₅)₂B; (C₅F₄)₃B; (C₆F₅)BF₂; BF(C₆F₅)₂; B(C₆F₅)₃; BCl₂(C₆F₅); BCl(C₆F₅)₂; B(C₆H₅) (C₆F₅)₂; B(Ph)₂ (C₆F₅); [C₆H₄ (mCF₃)]₃B; [C₆H₄(pOCF₃)]₃B; (C₆F₅)B(OH)₂; (C₆F₅)₂BOH; (C₆F₅)₂BH; (C₆F₅)BH₂; (C₇H₁₁)B(C₆F₅)₂; (C₈H₁₄B) (C₆F₅); (C₆F₅)₂B(OC₂H₅); (C₆F₅)₂B—CH₂CH₂Si(CH₃);

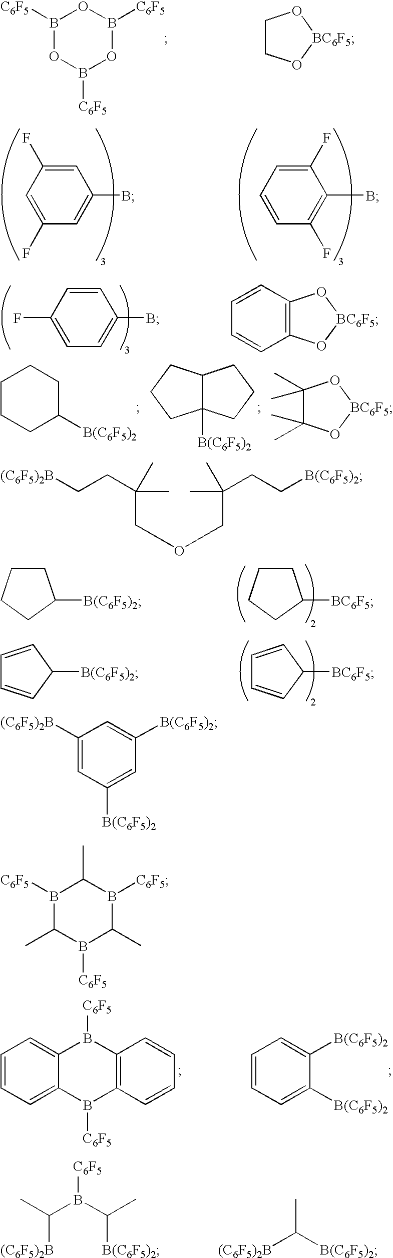

more preferably perfluorotriphenylborane [CAS No. 1109-15-5], and also mixtures of the above catalysts.

When these boron-containing catalysts are employed it is possible additionally to use synergistic compounds. These include salts or complexes with cations selected from the group of the salts of elements of transition groups 4, 6, 7, and 8 and also of main group 4. Anions of the synergistic compounds of the catalytic system that can be used with preference include alkoxylates, acid anions, especially carboxylates, sulfates, nitrates or phosphates, halides, especially chlorides, oxides or complex ligands, especially acetylacetonate or carbonyls.

Furthermore, unpublished patent application DE 103 12 634.1 describes a process for preparing organically modified polyorganosiloxanes using a catalytic mixture composed of at least one acid and at least one salt of an acid, by linkage of hydrosiloxanes with alcohols.

Suitable alcohols are, for example, linear or branched, saturated, mono- or polyunsaturated, aromatic, aliphatic-aromatic, optionally halogen atom-, especially fluorine atom-, containing monoalcohols or polyalcohols, polyether monoalcohols, polyether polyalcohols, polyester monoalcohols, polyester polyalcohols, amino alcohols, especially N-alkyl, arylamino-EO and -PO alcohols (EO stands for the ethylene oxide radical, PO for the isopropylene oxide radical), N-alkyl- or aryl-amino alcohols and also mixtures thereof, (meth)acrylated monoalcohols or polyalcohols, or a mixture thereof, or mixtures of the singly or multiply (meth)acrylated monoalcohols or polyalcohols.

As effective catalysts for the transition metal-catalyzed addition reaction of the SiH groups of the siloxane prepared in the first step with multiple carbon-carbon bonds it is possible to use the known hydrosilylation catalysts, for example: H₂PtCl₆, Pt[(CH₂CH—Si)₂O]ₙ or Rh(CO) (C₅H₇O₂).

Examples of suitable alkenyl/alkynyl compounds include ethene, ethyne, propene, 1-butene, 1-hexene, 1-dodecene, 1-hexadecene, allyl alcohol, 1-hexenol, allyl-functional polyethers, styrene, eugenol, allylphenol, methyl undecylenoate, vinylcyclohexene oxide, and allyl glycidyl ether.

The polyorganosiloxanes of the invention can be used for finishing textiles or as abhesive release coatings, UV-curing coatings, additives for UV-curing coatings, additives for plastics, paints, printing inks, and for cosmetic formulations, or in the architectural paint sector, as polyurethane foam stabilizers and/or as defoamers in non-aqueous media.

The invention will now be further described by way of the following non-limiting examples.

### EXAMPLES

### Preparation of Inventive Organosiloxanes

### Example 1

In a three-necked flask with stirrer, intensive condenser, and thermometer, 248 g of a siloxane of the general empirical formula Me₃Si—[SiMe₂O]₂₀—[SiMeHO]₅—SiMe₃ were mixed with 159 g of a divinylsiloxane of the general formula CH₂═CH—SiMe₂—[SiMe₂O]₂₅₀—SiMe₂—CH═CH₂, and 10 ppm of a Pt catalyst were added. The reaction mixture was subsequently heated at 90° C. for two hours.

This gave a siloxane mixture having a viscosity of 360 mpas. The viscosities were determined using a Brookf ield LVT viscometer (spindle 3, 4 or 5) in accordance with the manufacturer's instructions.

### Example 2

44 g of octanol are heated to 120° C. in a four-necked flask equipped with stirrer, intensive condenser, thermometer, and dropping funnel, together with 0.02 g (200 ppm) of tris(pentafluorophenyl)borane catalyst. When this temperature is reached, 215 g of the Si—H-functionalized polydimethylsiloxane prepared in 1a) are added dropwise over the course of 20 minutes. One hour after the completion of addition and cooling the conversion in accordance with the SiH value method was 0%.

### Example 3

50 g of 1-octenol are heated to 70° C. in a four-necked flask equipped with stirrer, intensive condenser, thermometer, and dropping funnel, together with 10 ppm of a platinum catalyst. When this temperature is reached, 215 g of the Si—H-functionalized polydimethylsiloxane prepared in Example 1 are added dropwise over the course of 30 minutes. One hour after the completion of addition and cooling the conversion in accordance with the SiH value method was 0%.

### Example 4

175 g of a polyether of the general empirical formula C₄H₉O[CH₂CH₂O]₇H are heated to 120° C. in a four-necked flask equipped with stirrer, intensive condenser, thermometer, and dropping funnel, together with 0.04 g of tris(pentafluorophenyl)borane catalyst. When this temperature is reached, 215 g of the Si—H-functionalized polydimethylsiloxane prepared in Example 1 are added dropwise over the course of 30 minutes. One hour after the completion of addition and cooling the conversion in accordance with the SiH value method was 0%.

### Performance Examples:

### Example 5:

### Defoaming of Motor Fuels

The siloxane of Example 3 was tested for its defoaming action in diesel fuel. For that purpose the siloxane was dissolved in a prior-art additive packet and a defined amount of this mixture was stirred into 1500 g of additive-free diesel fuel. The amount of siloxane is chosen so that the desired siloxane concentration varies between 8 and 15 ppm.

The results are set out in table 1.

TABLE 1

| | Use | Foam height | Foam collapse |
|---|---|---|---|
| | concentration | (mL) | time |
| Defoamer | (ppm) | dry | (sec) |
| Blank value | — | 110 | 20 |
| 3 | 8 | 40 | 15 |
| 3 | 15 | 25 | 10 |

Having thus described in detail various embodiments of the present invention, it is to be understood that the invention defined by the above paragraphs is not to be limited to particular details set forth in the above description as many apparent variations thereof are possible without departing from the spirit or scope of the present invention.

What is claimed is:

1. An organopolysiloxane produced by the process comprising:
A) addition reaction of organopolysiloxanes of the general formula I 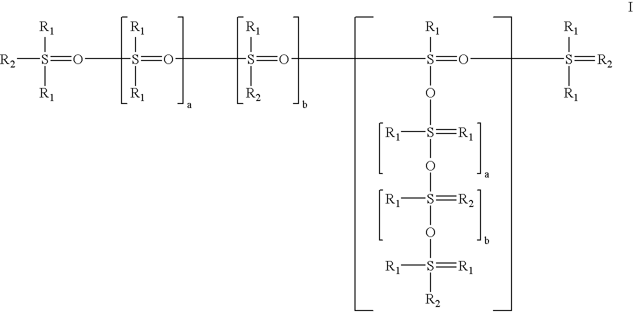
in which
R¹denotes identical or different aliphatic or aromatic hydrocarbon radicals having 1 to 20 carbon atoms,
R²denotes R¹ or H, with the proviso that at least three radicals R² are H,
a is 5 to 500,
b is 1 to 50,
c is 0 to 5,
with vinylsiloxanes of the general formula II, 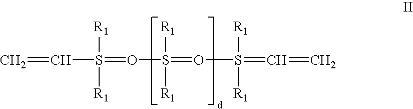
where
d is 10 to 1000,
in the presence of platinum catalysts or rhodium catalysts,
with the proviso that the organopolysiloxanes of the general formula I are present in a molar excess of at least 6 times, relative to the vinylsiloxane of the general formula II,
and further reaction of the reaction product in at least one of the following stages:
B) transition metal-catalyzed partial or complete addition reaction of the SiH groups with alkenyl and/or alkynyl compounds,
C) with the use of a catalyst, partial or complete reaction of the RSiH groups, remaining after above reaction(s), with at least one alcohol from the group of linear or branched, saturated, mono- or polyunsaturated, aromatic, aliphatic-aromatic, optionally halogen atom-containing monoalcohols, polyether monoalcohols, polyester monoalcohols, and amino alcohols.

2. The organopolysiloxane as claimed in claim 1, wherein R¹ is a methyl group.

3. The organopolysiloxane as claimed in claim 1, wherein boron-containing Lewis acids are used as catalyst for the addition reaction of the alcohol with the resultant SiH-containing siloxane.

4. The organopolysiloxane as claimed in claim 3, wherein perfluorotriphenylborane (C₅F₄)₃B is used as boron-containing Lewis acid.

5. The organopolysiloxane as claimed in claim 3, wherein a synergistic compound is used for the addition reaction of the alcohol, as well as boron-containing Lewis acids.

6. The organopolysiloxane as claimed in claim 5, wherein said synergistic compound is a salt or complex with cations selected from the group of the salts of elements of transition groups 4, 6, 7, and 8 and also of main group 4.

7. The organopolysiloxane as claimed in claim 1, wherein a catalytic mixture composed of at least one carboxylic acid and at least one salt of a carboxylic acid is used additionally as catalyst for the addition reaction of the alcohol with the resultant SiH-containing siloxane.

8. The organopolysiloxane as claimed in claim 1, wherein the viscosity is<10 000 mPas.

9. A process of defoaming a non-aqueous solution with comprises adding the organosiloxane of claim 1 into the non-aqueous solution.

10. A product selected from the group consisting of a finishing textile; an abhesive release coating; a UV-curing coating; an additive for UV-curing coating; an additive for plastics, paints, printing ink; and a polyurethane foam stabilizers wherein said product further comprises the organopolysiloxane of claim 1.
